(19) United States
(12) Patent Application Publication
(10) Pub. No.: US 2006/0269793 A1
(43) Pub. Date: Nov. 30, 2006

(54) Magnetic recording medium for longitudinal recording

(75) Inventors: Tatsuya Hinoue, Kanagawa (JP); Koji Sakamoto, Kanagawa (JP); Hiroyuki Suzuki, Kanagawa (JP); Takuya Kojima, Kanagawa (JP)

Correspondence Address: TOWNSEND AND TOWNSEND AND CREW LLP, TWO EMBARCADERO CENTER, 8TH FLOOR, SAN FRANCISCO, CA, 94111, US

(73) Assignee: Hitachi Global Storage Technologies Netherlands B. V., AZ Amsterdam (NL)

(21) Appl. No.: 11/440,504

(22) Filed: May 24, 2006

(30) Foreign Application Priority Data
May 26, 2005 (JP) 2005-153666

(51) Int. Cl. G11B 5/66

(52) U.S. Cl. 428/828.1; 428/829; 428/831; 428/836.1

(57) ABSTRACT

A longitudinal magnetic recording medium having high medium S/N ratio, no problem for overwriting characteristics, excellent bit error rate and also sufficient thermal stability is provided. In one embodiment, a medium has a substrate, an underlayer film formed above the substrate, a magnetic film formed by stacking a first magnetic layer, a second magnetic layer, a third magnetic layer, a non-magnetic intermediate layer and a fourth magnetic layer over the underlayer film, and a protective film formed over the magnetic film, in which each of the magnetic layers of the magnetic film comprises a cobalt-based alloy containing chromium, the first magnetic layer has the least thickness among all the magnetic layers, the second, the third and the fourth magnetic layer each further contain platinum and boron, Brt of the second magnetic layer is smaller than Brt of the third magnetic layer, Brt of the third magnetic layer is smaller than Brt of the fourth magnetic layer, and the ratio of Brt of the fourth magnetic layer to Brt of the entire magnetic film is within a range from about 40% to about 55%.

### CROSS-REFERENCES TO RELATED APPLICATIONS

This application claims priority from Japanese Patent Application No. JP2005-153666, filed May 26, 2005, the entire disclosure of which is incorporated herein by reference.

### BACKGROUND OF THE INVENTION

The present invention relates to a magnetic recording medium in which high density magnetic recording is attained. In particular, it relates to a magnetic disk in a longitudinal magnetic recording system.

Requirements for a larger capacity to magnetic disk apparatus have been increasing more and more. Therefore, it is advantageous to develop a magnetic head having high sensitivity and a magnetic recording medium having high S/N ratio and thermal stability. To improve the S/N ratio of the medium, it is necessary to improve the reading output when recorded at a high density. In general, a magnetic recording medium comprises, a first underlayer formed on a substrate as a so-called seed layer, a second underlayer with a body-centered cubic structure comprising an alloy having chromium as a main ingredient, a magnetic film and a protective film mainly composed of carbon. As the magnetic film, mainly an alloy with a hexagonal close-packed structure comprising cobalt as a main ingredient is used. In order to improve the reading output, it is useful to make the c-axis of the hexagonal close-packed structure, which is the easy axis of magnetization, parallel to the film surface by making the crystallographic orientation of (11.0) plane or (10.0) plane of the magnetic film substantially parallel to the surface of the substrate. It is known that the crystallographic orientation of the magnetic film can be controlled by a seed layer.

As a technique to achieve compatibility between the thermal stability and noise reduction, Patent Document 1 (Japanese Patent Laid-Open No. 7-134820) discloses a magnetic recording medium in which an underlayer formed on a substrate. Over the underlayer, a plurality of laminated magnetic films comprising at least two magnetic layers in contact with each other and having different compositions are formed by way of a non-magnetic layer. Patent Document 2 (US 2002/98390A) discloses a longitudinal magnetic recording medium stacked on a substrate, wherein the magnetic recording layer comprises an AFC layer, a ferromagnetic layer, and a non-ferromagnetic spacer separating the AFC layer and the ferromagnetic layer, in which the AFC layer comprises a first magnetic layer, a second magnetic layer and an anti-ferromagnetic coupling layer between the first and the second magnetic layer. The anti-ferromagnetic coupling layer of the AFC layer also has a thickness and a composition that provide an anti-ferromagnetic exchange coupling between the first and the second magnetic layer. The non-ferromagnetic spacer formed between the AFC layer and the ferromagnetic layer has a thickness and a composition that provides no exchange coupling between the AFC layer and the ferromagnetic layer. As a technique of improving the output characteristics of the magnetic recording medium, Patent Document 3 (U.S. Pat. No. 3,576,372) discloses a magnetic recording medium in which a non-magnetic underlayer, a magnetic film, and a protective film are formed successively above the substrate, in which the non-magnetic underlayer film comprises Cr or Cr alloy, the magnetic film has a plurality of magnetic layers comprising a Co alloy containing Cr, and the Cr content in the magnetic layer is gradually lowered from the magnetic layer on the lower side to the magnetic layer on the upper side.

### BRIEF SUMMARY OF THE INVENTION

Improvements for the reading output and reduction of the medium noise are important to improve the medium S/N ratio. To reduce the medium noise or improve the output characteristics, there is a method of forming the magnetic layer into a multiple layer directly or indirectly by using the techniques as disclosed by the literatures described above. However, in order to attain an areal recording density of 160 Mb/mm² or more, it is not sufficient to just combine the methods described above. For further improvement of the medium S/N ratio, when a plurality of magnetic layers are stacked, it is necessary to optimize the number of magnetic layers to be stacked, the composition of each of the magnetic layers and the stacking directly or stacking indirectly by way of a non-magnetic layer.

It is a feature of the present invention to provide a longitudinal magnetic recording medium having a high medium S/N ratio, no problem in overwrite characteristics, an excellent bit error rate and sufficient thermal stability.

The magnetic recording medium according to an aspect of the present invention comprises a substrate, an underlayer formed above the substrate, a magnetic film formed by stacking a first magnetic layer, a second magnetic layer, a third magnetic layer, a non-magnetic intermediate layer and a fourth magnetic layer above the underlayer film, and a protective film formed over the magnetic film, in which each of the magnetic layers of the magnetic film comprises a cobalt-based alloy containing chromium. The first magnetic layer has the least thickness among all the magnetic layers, the second, the third and the fourth magnetic layer each further contain platinum and boron. The Brt of the second magnetic layer is smaller than Brt of the third magnetic layer, while the Brt of the third magnetic layer is smaller than Brt of the fourth magnetic layer. The ratio of Brt of the fourth magnetic layer to Brt of the entire magnetic film is within a range from about 40% to 55%.

In one embodiment, the underlayer film comprises a first underlayer, a second underlayer, and a third underlayer. The first and the second underlayer each are an amorphous alloy layer. The third underlayer is a chromium-titanium-boron alloy layer. The first magnetic layer comprises a cobalt-chromium alloy or a cobalt-chromium-platinum alloy. The content of boron contained in the second magnetic layer is less than the content of boron contained in the third magnetic layer. The non-magnetic intermediate layer contains ruthenium.

In another embodiment, the underlayer film comprises a first underlayer, a second underlayer, and a third underlayer. The first and the second underlayer each are an amorphous alloy layer. The third underlayer is a chromium-titanium-boron alloy layer with the boron content of about 1 at. % or more and about 6 at. % or less. The first magnetic layer comprises a cobalt-chromium alloy or a cobalt-chromium-platinum alloy with the chromium content of about 34 at. % or less. The content of boron contained in the second magnetic layer is less than the content of boron contained in the third magnetic layer. The content of boron contained in the third magnetic layer is about 8 at. % or more. The non-magnetic intermediate layer contains ruthenium.

In yet another embodiment, the underlayer film comprises a first underlayer, a second underlayer, and a third underlayer. The first and the second underlayer each are an amorphous alloy layer. The third underlayer is a chromium-titanium-boron alloy layer with the boron content of about 1 at. % or more and about 6 at. % or less. The first magnetic layer comprises a cobalt-chromium alloy or a cobalt-chromium-platinum alloy with the chromium content of about 34 at. % or less. The content of boron contained in the second magnetic layer is less than the content of boron contained in the third magnetic layer, and the second magnetic layer further contains tantalum. The content of boron contained in the third magnetic layer is about 8 at. % or more. The non-magnetic intermediate layer contains ruthenium.

In some embodiments, the coercivity of the third and the fourth magnetic layer is about 160 kA/m or more. The third and the fourth magnetic layer are magnetically separated by the non-magnetic intermediate layer. All the magnetic layers in the magnetic film are magnetized in the same direction.

The magnetic recording medium according to another aspect of the invention comprises a substrate, an underlayer film formed above the substrate, a magnetic film formed by stacking a first magnetic layer, a second magnetic layer, a third magnetic layer, a non-magnetic intermediate layer and a fourth magnetic layer over the underlayer film, and a protective film formed over the magnetic film, in which each of the magnetic layers of the magnetic film is a cobalt-based alloy containing chromium; the second, the third and the fourth magnetic layer each further contain platinum and boron; the first magnetic layer is formed directly on the underlayer film; the second magnetic layer is formed directly on the first magnetic layer; the third magnetic layer is formed directly on the second magnetic layer; the fourth magnetic layer is formed over the third magnetic layer by way of the non-magnetic intermediate layer; and, the first magnetic layer has the least thickness and the fourth magnetic layer has the greatest thickness among all the magnetic layers.

In one embodiment, the underlayer film comprises a first underlayer, a second underlayer, and a third underlayer. The first and the second underlayer each are an amorphous alloy layer. The third underlayer is a chromium-titanium-boron alloy layer. The first magnetic layer comprises a cobalt-chromium alloy or a cobalt-chromium-platinum alloy. The content of boron contained in the second magnetic layer is less than the content of boron contained in the third magnetic layer. The non-magnetic intermediate layer contains ruthenium.

In another embodiment, the underlayer film has a first underlayer, a second underlayer, and a third underlayer. The first and the second underlayer each are an amorphous alloy layer. The third underlayer is a chromium-titanium-boron alloy layer with the boron content of about 1 at. % or more and about 6 at. % or less. The first magnetic layer comprises a cobalt-chromium alloy or a cobalt-chromium-platinum alloy with the chromium content of about 34 at. % or less. The content of boron contained in the second magnetic layer is less than the content of boron contained in the third magnetic layer. The content of boron contained in the third magnetic layer is about 8 at. % or more. The non-magnetic intermediate layer preferably contains ruthenium.

In yet another embodiment, the underlayer film has a first underlayer, a second underlayer, and a third underlayer. The first and the second underlayer each are an amorphous alloy layer. The third underlayer is a chromium-titanium-boron alloy layer with the boron content of about 1 at. % or more and about 6 at. % or less. The first magnetic layer comprises a cobalt-chromium alloy or a cobalt-chromium platinum alloy with the chromium content of about 34 at. % or less. The content of boron contained in the second magnetic layer is less than the content of boron contained in the third magnetic layer, the layer further containing tantalum. The content of boron contained in the third magnetic layer is about 8 at. % or more. The non-magnetic intermediate layer contains ruthenium.

In specific embodiments, the coercivity of the third and the fourth magnetic layer is about 160 kA/m or more. The third and the fourth magnetic layers are magnetically separated by the non-magnetic intermediate layer. All the magnetic layers in the magnetic film are magnetized in the same direction.

According to the invention, it is possible to provide a longitudinal magnetic recording medium having high medium S/N ratio, no problem for overwriting characteristics, excellent bit error rate and also sufficient thermal stability.

### BRIEF DESCRIPTION OF THE DRAWINGS

FIG. 1 is a cross sectional view showing the constitution of a magnetic disk according to an example of the present invention.

FIG. 2 is a plane view showing the constitution of a magnetic disk drive on which a magnetic disk of the invention is mounted.

FIG. 3 is a schematic perspective view showing the constitution of a magnetic head.

FIG. 4 is a view showing characteristics of a magnetic head used for the measurement of recording performance of a magnetic disk.

FIG. 5 is a view showing recording performance of a magnetic disk according to Example 1.

FIG. 6 is a view showing recording performance of Comparative Example 1.

FIG. 7 is a view showing recording performance of Comparative Example 2.

FIG. 8 is a view showing recording performance of Comparative Example 3.

FIG. 9 is a view showing recording performance of Comparative Example 4.

FIG. 10 is a view showing recording performance of Comparative Example 6.

FIG. 11 is a view showing recording performance of a magnetic disk according to Example 2.

FIG. 12 is a view showing recording performance of a magnetic disk according to Example 3.

FIG. 13 is a view showing recording performance of a magnetic disk according to Example 4.

FIG. 14 is a view showing recording performance of a magnetic disk according to Example 5.

FIG. 15 is a view showing the dependence on the thickness of the first magnetic layer of a magnetic disk according to Example 6.

FIG. 16 is a view showing recording performance of a magnetic disk according to Example 6.

FIG. 17 is a view showing the dependence on the thickness of the first magnetic layer of a magnetic disk according to Example 7.

FIG. 18 is a view showing recording performance of a magnetic disk according to Example 7.

FIG. 19 is a view showing the dependence on the thickness of the first magnetic layer of the magnetic disk according to Example 8.

FIG. 20 is a view showing the dependence on the thickness of the first magnetic layer of the magnetic disk according to Example 9.

### DETAILED DESCRIPTION OF THE INVENTION

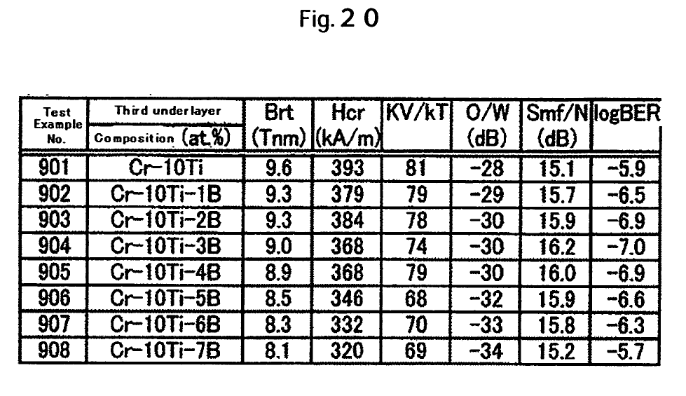

At first, an example of a magnetic disk drive mounting a magnetic recording medium (magnetic disk) according to an example to be described below with reference to FIG. 2 is shown. A magnetic disk drive 10 comprises a magnetic disk 1, a spindle motor 3 carrying and rotating the magnetic disk 1, a magnetic head 4 for reading and writing the magnetic disk 1, a suspension 5 for supporting the magnetic head 4, a carriage 6 attached with the suspension 5 and holding a voice coil 7, magnetic circuits 8 disposed above and below the voice coil 7, and a ramp mechanism 9 retracting the magnetic head 4 upon unloading the magnetic head 4. When electric current is supplied to the voice coil 7, the carriage 6 rotates and the magnetic head 4 supported by the suspension 5 moves in the radial direction of the magnetic disk 1.

FIG. 3 is a schematic perspective view showing the structure of the magnetic head 4. The magnetic head 4 is a composite type head having a magnetoresistive head for reading and an electromagnetic inductive head for recording formed over a substrate 40. The magnetoresistive type head has a magnetoresistive sensor 42 disposed between the lower magnetic shield 41 and a upper magnetic shield 44, and electrodes 43 for taking out signals are disposed on both ends of the magnetoresistive sensor 42. In this case, the reading track width is referred to as Twr and the distance between the two shield layers is referred to as Gs. The electromagnetic induction type head has a lower magnetic pole 46 disposed over an insulative separation layer 45, an upper magnetic pole 48 constituting a closed magnetic circuit with the lower magnetic pole 46, and coils 47 disposed so as to intersect the closed magnetic circuit. In this case, the writing width is referred to as Tww and the writing gap length is referred to as Gl. In the drawing, the gap layer between the shield layer and the magnetoresistive sensor and the gap layer between recording magnetic poles are not shown.

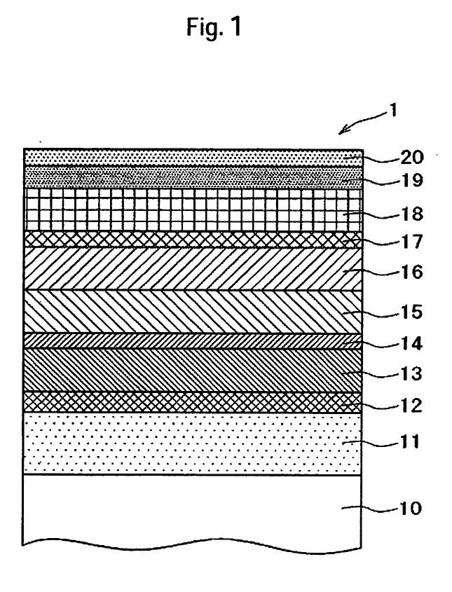

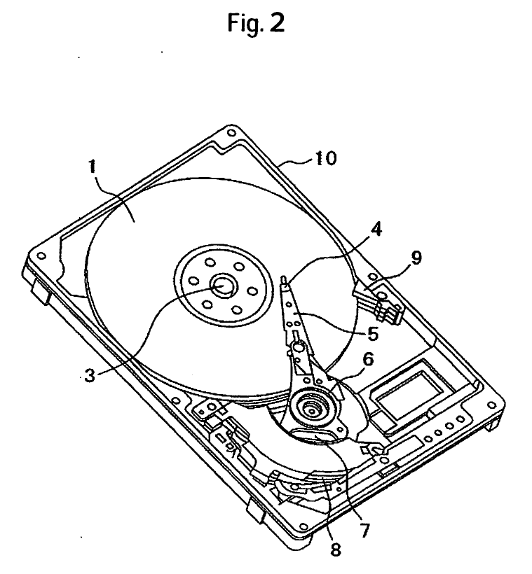

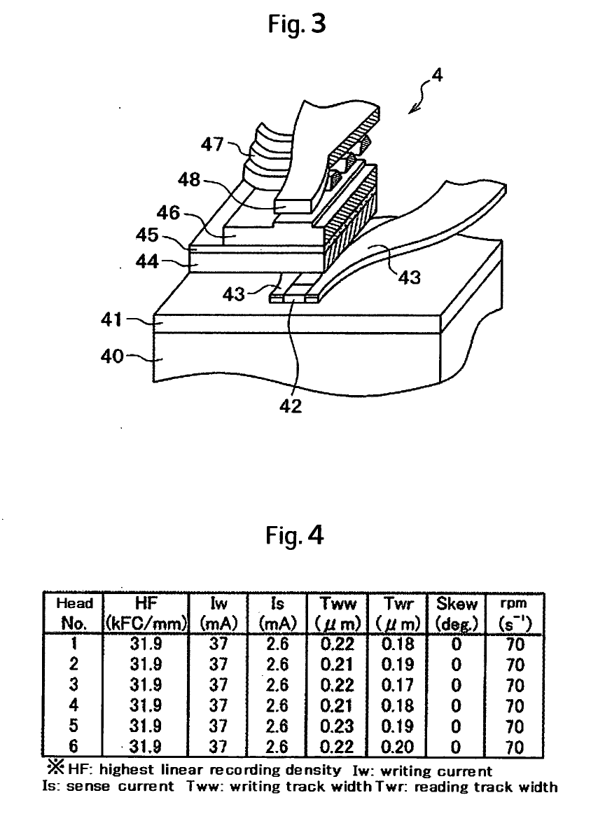

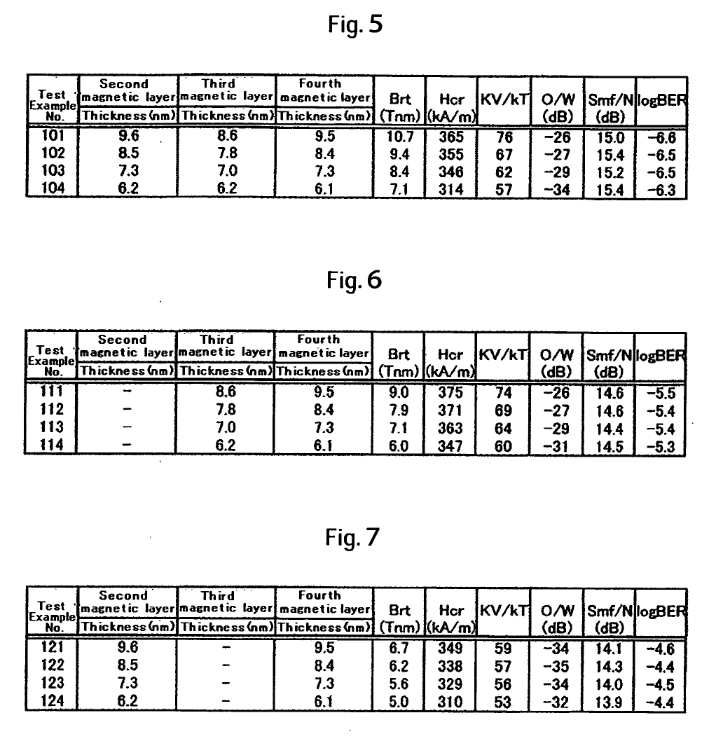

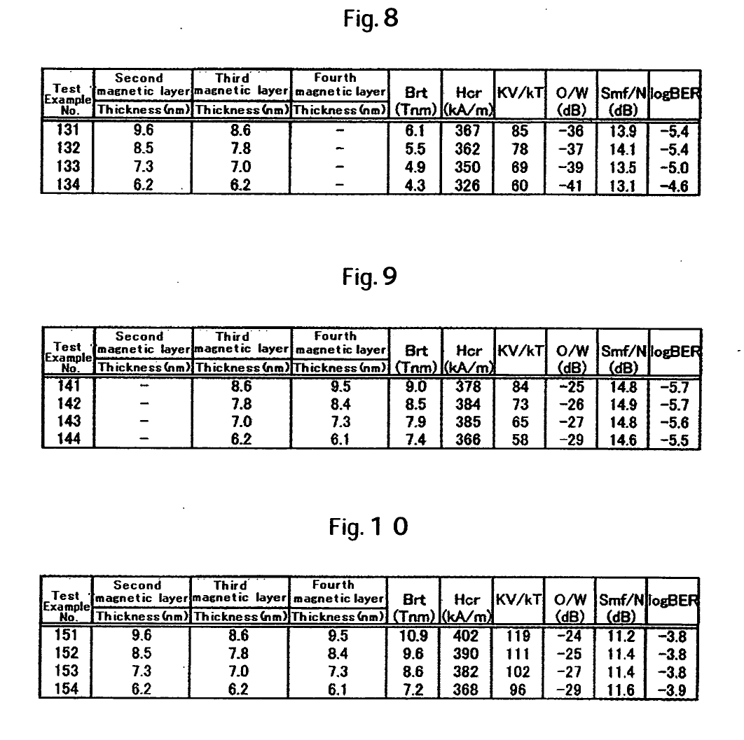

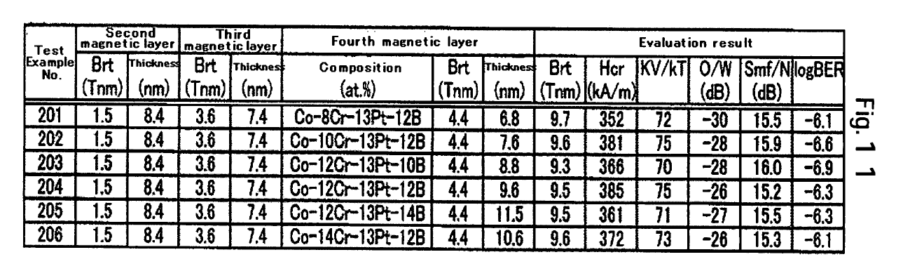

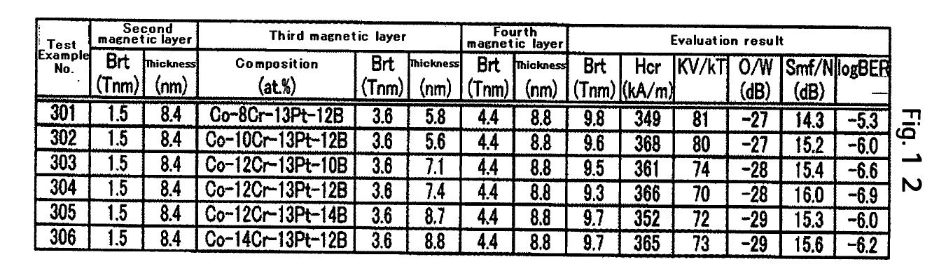

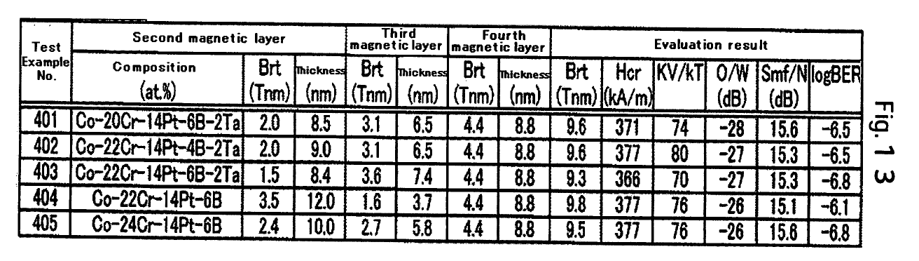

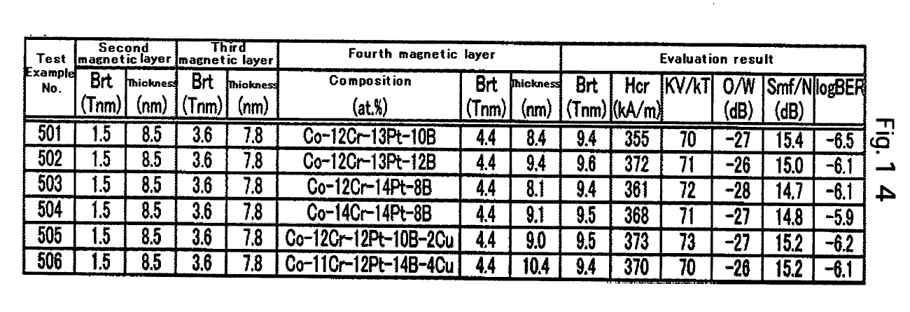

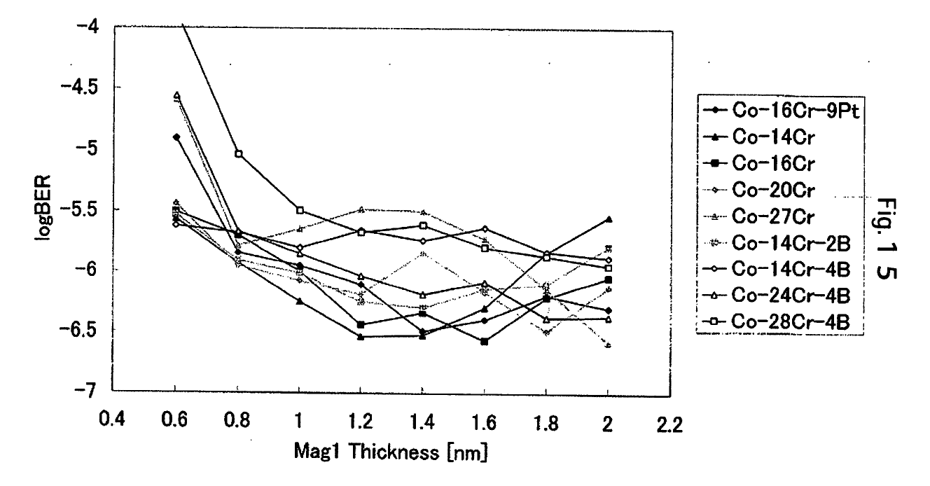

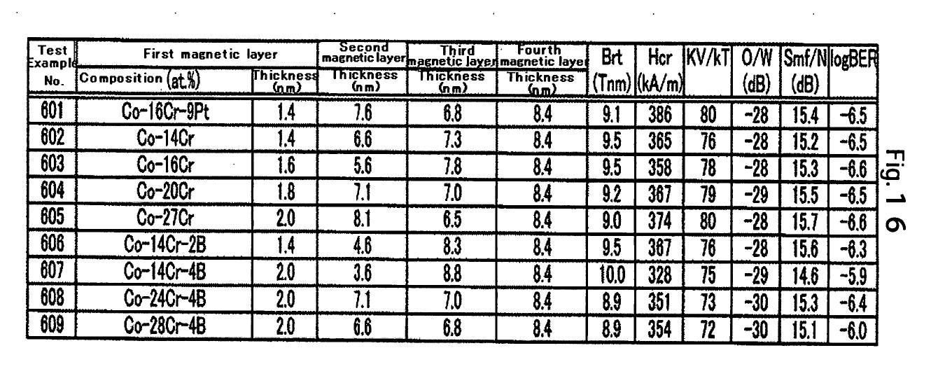

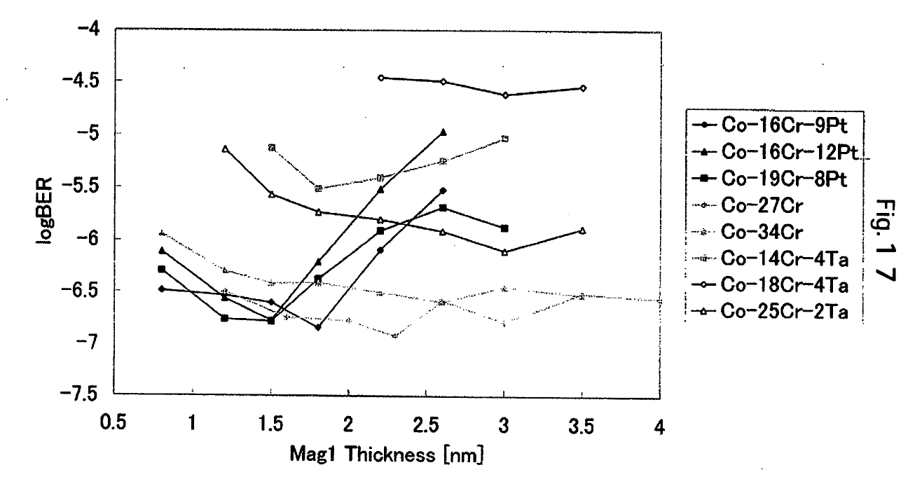

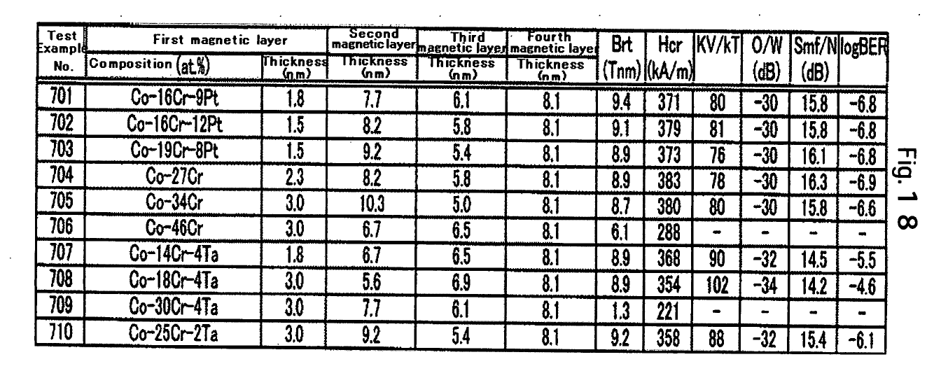

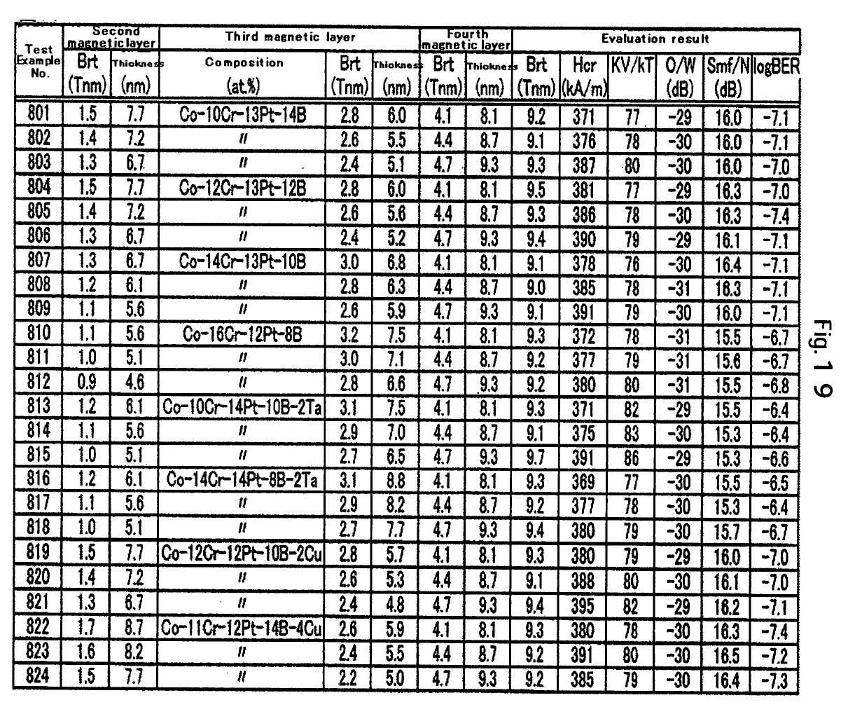

FIG. 1 shows a cross sectional constitution of a magnetic recording medium (magnetic disk) according to an embodiment of the invention. Since the magnetic disk 1 has identical constitution for both surfaces of the substrate 10, only the single surface is shown in FIG. 1. The magnetic disk 1 has a film structure formed on a substrate 10 by stacking successively an underlayer film (first underlayer 11, second underlayer 12, and third underlayer 13), a magnetic film (first magnetic layer 14, a second magnetic layer 15, a third magnetic layer 16, a non-magnetic intermediate layer 17 and a fourth magnetized layer 18), a protective film 19, and a lubrication film 20. As the substrate 10, a chemically reinforced glass substrate, or a rigid substrate formed by plating a nickel alloy containing phosphorous to an aluminum alloy is used preferably. It is preferred, in view of providing magnetic anisotropy, to apply fine texturing substantially in the circumferential direction of a disk on the substrate. Based on test results, it was confirmed that the flying reliability of the magnetic head was sufficient in the case of using a substrate at a maximum height Rmax of 2.68 nm to 4.2 nm, and an average surface roughness Ra of from 0.23 nm to 0.44 nm, as a result of observation for the surface roughness measured in the diametrical direction of a disk over an extent of 5 μm square by an intermittent contact type atomic force microscope.

By forming an underlayer film between the substrate 10 and the first magnetic layer 14, it is possible to control the crystallographic orientation of the magnetic film and refine the crystal grain size. In this embodiment, a first underlayer comprising a Ti—Co—Ni alloy, a second underlayer comprising a W—Co alloy and a third underlayer with a body-centered cubic structure comprising a Cr—Ti—B alloy are disposed between the substrate and the first magnetic layer. The magnetic film is constituted by stacking four magnetic layers, in which a first magnetic layer 14, a second magnetic layer 15, and a third magnetic 16 are stacked directly by sputtering continuously, and a fourth magnetic layer 18 is formed over the third magnetic layer 16 by way of a non-magnetic intermediate layer 17 comprising Ru, etc. By setting the coercivity of the third magnetic layer 16 and the fourth magnetic layer 18 to about 160 kA/m or more, the magnetic layers are not anti-ferromagnetically coupled but are magnetically separated by the non-magnetic intermediate layer 17. It is known that the medium noises are in inverse proportion to the square root of the number of magnetic particles in the recording layer responsible for recording. Since the medium has two recording layers and substantially twice the number of the magnetic particles responsible for recording, by magnetically separating the third magnetic layer 16 and the forth magnetic layer 18, the medium noise decreases and S/N ratio improves.

As the first magnetic layer 14, a cobalt-based alloy such as a Co—Cr alloy or a Co—Cr—Pt alloy is used. When the thickness of the first magnetic layer 14 is less than the thickness of the magnetic layer of the second magnetic layer 15 and the subsequent layers formed thereabove, the crystal grain size of the magnetic layers is refined to decrease the medium noise. For the second, third, and fourth magnetic layers 15, 16, and 18, Co-based alloys containing Cr, Pt, and B such as Co—Cr—Pt—B alloy, Co—Cr—Pt—B—Ta alloy, and Co—Cr—Pt—B—Cu alloy are used. For the product of the residual magnetization Br and the thickness t of the magnetic layers Brt, the writability of the medium improves when Brt of the second magnetic layer 15 is smaller than Brt of the third magnetic layer 16, Brt of the third magnetic layer 16 is smaller than Brt of the fourth magnetic layer 18, and the ratio of Brt of the fourth magnetic layer 18 in the entire Brt of the medium is within a range from about 40% to 55%. The direction of magnetization in each of the magnetic layers is in a same direction after the writing by a magnetic head.

For the magnetic film of the constitution described above, it is preferred that the concentration of Cr contained in the first magnetic layer 14 is about 34 at. % or less in order to stabilize the crystallographic orientation of the magnetic layer.

For high medium S/N ratio, it is preferred that the concentration of B contained in the second magnetic layer is lower than the concentration of B contained in the third magnetic layer 16 because the crystallographic orientation of the magnetic layer improves.

The coercivity of the medium is ensured by adding Pt to the second magnetic layer 15 and the magnetic layers over the second magnetic layer 15. The crystal grain size of the magnetic layer is refined and the medium noise is reduced by adding B to the second magnetic layer 15 and the magnetic layers over the second magnetic layer 15.

By adding Ta to the second magnetic layer 15, the writability of the medium improves because the anisotropic magnetic field in the magnetic layer nearer to the substrate 10 is difficult for the head magnetic fields to reach.

The underlayer film, the magnetic film, and the protective film are formed on the substrate by sputtering targets. As the physical vapor deposition method, a method such as RF sputtering, DC pulse sputtering, etc. are also effective in addition to DC sputtering. In the case of using the DC sputtering, it is preferred to apply a bias voltage in the process at or after the second magnetic layer in view of the increase of the coercivity.

In a magnetic disk drive mounting the magnetic disk of the composition described above, an areal recording density of 160 Mb/mm² or more can be obtained.

Manufacturing methods and compositions for each of examples are to be described specifically.

### EXAMPLE 1

An aluminosilicate glass substrate 10 chemically reinforced at the surface was cleaned by alkali cleaning and dried. Then, a Ti-40 at. % Co-10 at. % Ni alloy layer with a 15 nm thickness as a first underlayer 11, and a W-30 at. % Co alloy layer with a 3 nm thickness as a second underlayer 12 were formed at a room temperature. Successively, after heating the substrate 10 to a temperature of about 360 to 400° C. by a lump heater, a Cr-10 at. % Ti-3 at. % B alloy with an 8 nm thickness was formed as a third underlayer 13. Further, after forming a Co-16 at. % Cr-9 at. % Pt alloy layer with a 1.2 nm thickness as a first magnetic layer 14, a second magnetic layer 15 comprising a Co-22 at. % Cr-14 at. % Pt-6 at. % B-2 at. % Ta alloy, a third magnetic layer 16 comprising a Co-12 at. % Cr-13 at. % Pt-12 at. % B alloy, a non-magnetic intermediate layer 17 comprising Ru with a 0.8 nm thickness, and a fourth magnetic layer 18 comprising a Co-12 at. % Cr-13 at. % Pt-10 at. % B alloy, a film 19 with a 3 nm thickness comprising carbon as a main ingredient was formed as a protective film. After forming the protective film, a lubricant comprising a perfluoro alkyl polyether as a main ingredient was coated to form a lubrication film 20 with a 1.8 nm thickness.

The multi-layered film was formed by using a sputtering apparatus with single disk process. In the sputtering apparatus, the base vacuum pressure was 1.0 to 1.2×10⁻⁵ Pa and the tact time was 9 sec. The first underlayer to the third magnetic layer were formed in an Ar gas atmosphere at 0.53 to 0.93 Pa. Heating was done in a mixed gas atmosphere in which 1% oxygen was added to Ar. The carbon protective film was formed in a mixed gas atmosphere in which 10% nitrogen was added to Ar. A bias voltage at −200V was applied to the substrate 10 during sputtering the third underlayer 13, the second magnetic layer 15, the third magnetic layer 16 and the fourth magnetic layer 18. The discharge time was 4.5 sec for the first underlayer 11, the second magnetic layer 15, the third magnetic layer 16, and the fourth magnetic layer 18; the discharge time was 2.5 sec for the second underlayer 12, the first magnetic layer 14 and the non-magnetic intermediate layer 17; and the discharge time was 4.0 sec for the third underlayer 16. Brt (Br: residual magnetization of the magnetic layer, t: thickness of the magnetic layer) and the remanent coercivity Hcr of the manufactured medium were measured by using a Fast Remanent Moment Magnetometer (FRMM). KV/kT (K: magnetocrystalline anisotropy, V: volume of magnetic crystal particle, k: Boltzman's constant, T: absolute temperature) was determined with a vibration sample magnetometer (VSM) by evaluating the time dependence of the remanent coercivity from 7.5 sec to 240 sec at a room temperature and fitting to the Sharrock's formula. According to the studies made by the inventors, when KV/kT determined by this method was about 70 or more, the output decay caused by thermal fluctuation was suppressed to result in no problem in view of the reliability.

The recording performance was evaluated with a spin stand by using a composite type head having an electromagnetic induction type magnetic head for writing and a spin-valve type magnetic head for reading together. FIG. 4 shows the characteristics of heads used in this example and other examples. This shows the highest linear recording density HF (kFC/mm), writing current Iw (mA), sense current Is (mA), writing track width Tww (μm), reading track width Twr (μm), skew angle Skew (deg.), and number of rotation (s⁻¹) for each of the head samples Nos. 1 to 6. Head sample No. 1 was used for the evaluation of this example. The signal-to-noise ratio Smf/N was determined based on the output when recorded at a medium recording density MF=HF/2 and medium noises at highest recording density HF. After recording at a low recording density LF=HF/10, a high recording density HF signal was overwritten to determine the overwriting performance O/W based on the decay ratio of an LF signal. The bit error rate (BER) was determined by counting the number of error bytes relative to the number of total read bytes just after recording substantially over one turn for a specified track with a random pattern.

FIG. 5 shows the result of evaluation in this example (Test Examples 101 to 104). Brt (Tnm), Hcr (kA/m), KV/kT, O/W (dB), Smf/N (dB), and logarithmic of BER logBER of media in the case of changing the thickness of the second magnetic layer 15, the third magnetic layer 16 and the fourth magnetic layer 18 are shown. As the thickness of the second, the third and the fourth magnetic layers decreased, Brt was decreased and KV/kT deteriorated. As the thickness of the second, the third and the fourth magnetic layers decreased, O/W was improved. Smf/N and logBER did not greatly depend on the thickness. Smf/N showed satisfactory values of 15 dB or more in all of the cases. logBER showed extremely satisfactory values of −6 order or less in all of the cases. Judging from the results mentioned above, KV/kT can be controlled without degrading Smf/N or logBER by changing the thickness of the second, the third and the fourth magnetic layers. However, since the O/W performance is deteriorated as the thickness increases, degradation for O/W performance has to be restricted within an allowable range. According to the studies made by the inventors, there was no problem in view of the writability at low temperature when O/W was −25 dB or less.

### COMPARATIVE EXAMPLE 1

As Comparative Example 1, a medium without the second magnetic layer 15 in Example 1 was manufactured. FIG. 6 shows the result of evaluation for this comparative example (Test Examples 111 to 114). For the evaluation of the recording performance, the identical head with that in Example 1 was used. Compared with the medium of Example 1, Smf/N was degraded by 0.4 dB or more, and logBER was degraded by one order or more. This is because the formation of the second magnetic layer 15 which has higher Cr concentration than other magnetic layers is effective for reducing the medium noises. Thus, it is found that the formation of the second magnetic layer 15 in Example 1 is essential for the improvement of the medium performance.

### COMPARATIVE EXAMPLE 2

As Comparative Example 2, a medium without the third magnetic layer 16 in Example 1 was manufactured. FIG. 7 shows the result of evaluation for this comparative example (Test Examples 121 to 124). For the evaluation of the recording performance, the identical head with that in Example 1 was used. Compared with the medium of Example 1, Smf/N was degraded by about 1 dB or more, and logBER was degraded by about one order or more. When the magnetization curve of the medium of this Comparative Example 2 was measured by VSM, the magnetization curve showed a stepwise shape. In a case where the third magnetic layer 16 was not formed, the coercivity of the portion of the magnetic layer formed by stacking the first magnetic layer 14 and the second magnetic layer 15 was remarkably lowered than the coercivity of the fourth magnetic layer separated by the non-magnetic intermediate layer 17, and the magnetization curve showed the stepwise shape. It is considered that the significant difference of the coercivity between the two magnetic layers related to recording affects the recording performance to greatly deteriorate Smf/N and logBER. Judging from the results mentioned above, the formation of the third magnetic layer 16 in Example 1 is essential for the improvement of the medium performance.

### COMPARATIVE EXAMPLE 3

As Comparative Example 3, a medium without the non-magnetic intermediate layer 17 and the fourth magnetic layer 18 in Example 1 was manufactured. FIG. 8 shows the result of evaluation for this comparative example (Test Examples 131 to 134). For the evaluation of the recording performance, the identical head with that in Example 1 was used. Compared with the medium of Example 1, Smf/N was degraded by about 1 dB or more, and logBER was degraded by about one order or more. It is considered that in the case of not forming the non-magnetic intermediate layer 17 and the fourth magnetic layer 18, since the magnetic layer related with recording is substantially only one layer, the number of magnetic particles related with recording is decreased and the media noise is decreased. Further, it is considered that the insufficient output also causes degradation of performance for the medium with small Brt such as Test Example number 134. Judging from the results mentioned above, the non-magnetic intermediate layer 17 and the fourth magnet layer 18 in Example 1 are essential for the improvement of the medium performance.

### COMPARATIVE EXAMPLE 4

As a Comparative Example 4, a medium in which a Ru intermediate layer with 0.6 nm thickness was formed instead of a second magnetic layer 15 in Example 1 was manufactured. FIG. 9 shows the result of evaluation of this comparative example (Test Examples 141 to 144). The identical head with that for Example 1 was used for the evaluation of the recording performance. Compared with the medium of Example 1, Smf/N was degraded by 0.1 to 0.8 dB and logBER was degraded by 0.6 to 1.1 order. In the case of forming Ru with 0.6 nm thickness instead of the second magnetic layer 15 in Example 1, the first magnetic layer 14 and the second magnetic layer 15 are coupled antiferromagnetically such that the magnetization of each of the layers are in anti parallel with each other. Generally, it is considered that the medium performance is improved in the case of applying such antiferromagnetic coupling. However, in the case of this Comparative Example 4, it is considered that the increase of the noise caused by the absence of the second magnetic layer 15 with high Cr concentration results in degradation of the medium performance. Judging from the results mentioned above, even when the antiferromagnetic coupling is adopted, which is considered generally advantageous for the improvement of the medium performance, the medium performance is rather deteriorated in the case of decreasing the number of the magnetic layers is decreased from 4 to 3 layers.

### COMPARATIVE EXAMPLE 5

As Comparative Example 5, a medium without the first magnetic layer 14 of Example 1 was manufactured. In this comparative example, measuring error that occurred in the evaluation by FRMM and the magnetic characteristics could not be evaluated. In the case of forming a magnetic layer comprising Co alloy containing Pt and B directly on a Cr—Ti—B alloy underlayer, the Co alloy magnetic layer is not epitaxially grown on the underlayer and the magnetic layer does not have in-plane orientation. Since the in-plane orientation could not be obtained in the magnetic layer at or after the second magnetic layer 15 because the first magnetic layer 14 was not formed, the medium performance was extremely deteriorated to the extent that the magnetic characteristics could not be evaluated. Judging from the results mentioned above, the first magnetic layer 14 is essential for obtaining an in-plane orientation necessary for the longitudinal magnetic recording medium.

Judging from the results of Comparative Examples 1 to 5, at least four magnetic layers are necessary in order to improve the medium performance.

### COMPARATIVE EXAMPLE 6

As Comparative Example 6, a medium without the non-magnetic intermediate layer 17 in Example 1 was manufactured. FIG. 10 shows the result of evaluation for this comparative example (Test Examples 151 to 154). The identical head with that for Example 1 was used for the evaluation of the recording performance. While KV/kT was increased by about 40 compared with the medium of Example 1, Smf/N was degraded by about 4 dB and logBER was degraded by about 2.5 order. In a case where the recording layer is separated into two layers by forming the non-magnetic intermediate layer 17 between the third magnetic layer 16 and the fourth magnetic layer 18, the number of magnetic particles related to recording increased about twice. Therefore, the medium noise could be decreased. Without forming non-magnetic intermediate layer 17 in Example 1, the medium noise increased greatly. The formation of the non-magnetic intermediate layer 17 between the third magnetic layer 16 and the fourth magnetic layer 18 is essential for the improvement of the medium performance.

### EXAMPLE 2

In the same manner as in Example 1, after forming from the first underlayer 11 to the non-magnetic intermediate layer 17, each of the following alloy layers was formed as the fourth magnetic layer 18.

Co-8 at. % Cr-13 at. % Pt-12 at. % B,

Co-10 at. % Cr-13 at. % Pt-12 at. % B,

Co-12 at. % Cr-13 at. % Pt-10 at. % B,

Co-12 at. % Cr-13 at. % Pt-12 at. % B,

Co-12 at. % Cr-13 at. % Pt-14 at. % B,

Co-14 at. % Cr-13 at. % Pt-12 at. % B.

A protective film 19 and a lubrication film 20 were formed over them in the same manner as in Example 1. FIG. 11 shows the result of evaluation for this example (Test Examples 201 to 206). Head No. 2 of FIG. 4 was used for the evaluation of the recording performance. Brt for each of the magnetic layers in the figure is a design value. In all of test examples, good KV/kT of 70 or more, good O/W of −25 dB or less, good Smf/N of 15 dB or more and excellent logBER of −6 order or less were obtained. In particular, in the case of using an alloy with a total concentration of Cr and B of 22 at. %, that is, a total concentration of Co and Pt of 78 at. % as in Test Examples 202 and 203, the best Smf/N and logBER were obtained.

### EXAMPLE 3

In the same manner as in Example 1, after forming from the first underlayer 11 to the second magnetic layer 15, each of the following alloy layers was formed as the third magnetic layer 16.

Co-8 at. % Cr-13 at. % Pt-12 at. % B,

Co-10 at. % Cr-13 at. % Pt-12 at. % B,

Co-12 at. % Cr-13 at. % Pt-10 at. % B,

Co-12 at. % Cr-13 at. % Pt-12 at. % B,

Co-12 at. % Cr-13 at. % Pt-14 at. % B,

Co-14 at. % Cr-13 at. % Pt-12 at. % B.

A non-magnetic intermediate layer 17, a fourth magnetic layer 18, a protective film 19 and a lubrication film 20 were formed over them in the same manner as in Example 1. FIG. 12 shows the result of evaluation for this example (Test Examples 301 to 306). Head No. 2 of FIG. 4 was used for the evaluation of the recording performance. Brt for each of the magnetic layers in the figure is a design value. In all of the test examples, except for Test Example 301, good KV/kT of 70 or more, good O/W of −25 dB or less, good Smf/N of 15 dB or more and excellent logBER of −6 order or less were obtained. In particular, in the case of using Co-12 at. % Cr-13 at. % Pt-12 at. % B alloy, the best Smf/N and logBER were obtained.

### EXAMPLE 4

After forming from the first underlayer 11 to the first magnetic layer 14 in the same manner as in Example 1, each of the following alloy layers was formed as a second magnetic layer 15.

Co-20 at. % Cr-14 at. % Pt-6 at. % B-2 at. % Ta,

Co-22 at. % Cr-14 at. % Pt-4 at. % B-2 at. % Ta,

Co-22 at. % Cr-14 at. % Pt-6 at. % B-2 at. % Ta,

Co-22 at. % Cr-14 at. % Pt-6 at. % B,

Co-24 at. % Cr-14 at. % Pt-6 at. % B.

A third magnetic layer 16, a non-magnetic intermediate layer 17, a fourth magnetic layer 18, a protective film 19, and a lubrication film 20 were formed over them in the same manner as in Example 1. FIG. 13 shows the result of evaluation for this example (Test Examples 401 to 405). Head No. 3 of FIG. 4 was used for the evaluation of the recording performance. Brt for each of the magnetic layers in the figure is a design value. In all of the test examples, good KV/kT of 70 or more, good O/W of −25 dB or less, good Smf/N of 15 dB or more and excellent logBER of −6 order or less were obtained. Smf/N and logBER of the medium of Test Example 404 using Co-22 at. % Cr-14 at. % Pt-6 at. % B were somewhat worse than other test examples. Since the Co-22 at. % Cr-14 at. % Pt-6 at. % B alloy is a material with the largest saturation magnetization as the second magnetic layer 15 in this test example, it is suggested that a material with smaller saturation magnetization is better as the material for the second magnetic layer 15. In all test examples except for Test Example 404, Brt of the second magnetic layer 15 is smaller than Brt of the third magnetic layer. Therefore, it is considered that if Brt for the second magnetic layer is smaller than Brt for the third magnetic layer, the medium performance is improved.

### EXAMPLE 5

After forming a first underlayer 11 to non-magnetic intermediate layer 17 in the same manner as in Example 1, each of the following alloy layers was formed as the fourth magnetic layer 18.

Co-12 at. % Cr-13 at. % Pt-10 at. % B,

Co-12 at. % Cr-13 at. % Pt-12 at. % B,

Co-12 at. % Cr-14 at. % Pt-8 at. % B,

Co-14 at. % Cr-14 at. % Pt-8 at. % B,

Co-12 at. % Cr-12 at. % Pt-10 at. % B-2 at. % Cu,

Co-11 at. % Cr-12 at. % Pt-14 at. % B-4 at. % Cu,

A protection film 19 and a lubrication film 20 were formed over them in the same manner as in Example 1. FIG. 14 shows the result of evaluation for this example (Test Examples 501 to 506). Head No. 4 in FIG. 4 was used for the evaluation of the recording performance. Brt for each of the magnetic layers in the figure is a design value. In all test examples, good KV/kT of 70 or more and good O/W of −25 dB or less were obtained. Smf/N of Test Examples 503 and 504 with the B concentration of 8 at. % which is lower than that of other media was somewhat lower than the media with B concentration of 10 at. % or more. Thus, the concentration of B in the fourth magnetic layer is preferably about 10 at. % or more.

### EXAMPLE 6

After forming from a first underlayer 11 to a third underlayer 13 in the same manner in Example 1, each of the following alloy layers with 0.6 to 2.0 nm thickness was formed as the first magnetic layer 14.

Co-16 at. % Cr-9 at. % Pt,

Co-14 at. % Cr,

Co-16 at. % Cr,

Co-20 at. % Cr,

Co-27 at. % Cr,

Co-14 at. % Cr-2 at. % B,

Co-14 at. % Cr-4 at. % B,

Co-24 at. % Cr-4 at. % B,

Co-28 at. % Cr-4 at. % B.

A second magnetic layer 14, a third magnetic layer 15, a non-magnetic intermediate layer 17, a fourth magnetic layer 18, a protective film 19 and a lubrication film 20 were formed over them in the same manner as in Example 1. FIG. 15 shows a graph for the dependence of BER on the thickness of the first magnetic layer 14. Head No. 5 in FIG. 4 was used for the evaluation of the recording performance. BER was degraded in each of the materials at the thickness of 0.8 nm or less, and this is considered to be caused by the crystallographic orientation being degraded at or after the second magnetic layer 15 as the thickness of the first magnetic layer 14 was reduced. The thickness at which the BER was optimized depended on the material, and the thickness at which the BER was optimized was larger in the material with higher Cr concentration and smaller magnetization. It is suggested that the value of Brt for the first magnetic layer 14 is related to the optimal thickness of the first magnetic layer 14. The first magnetic layer with B showed the same or worse BER than that without B. This is considered to be caused by B addition to the first magnetic layer 14 deteriorating the crystallographic orientation at or after the second magnetic layer 15 formed thereover. FIG. 16 shows the performance of each medium at the thickness at which BER was the best for each of the alloys for the first magnetic layer 14 (Test Examples 601 to 609).

### EXAMPLE 7

After forming from a first underlayer 11 to a third underlayer 13 in the same manner as in Example 1, each of the following alloy layers with 0.8 to 4.0 nm thickness was formed as a first magnetic layer.

Co-16 at. % Cr-9 at. % Pt,

Co-16 at. % Cr-12 at. % Pt,

Co-19 at. % Cr-8 at. % Pt,

Co-27 at. % Cr,

Co-34 at. % Cr,

Co-46 at. % Cr,

Co-14 at. % Cr-4 at. % Ta,

Co-18 at. % Cr-4 at. % Ta,

Co-30 at. % Cr-4 at. % Ta,

Co-25 at. % Cr-2 at. % Ta.

A Co-22 at. % Cr-14 at. % Pt-4 at. % B-2 at. % Ta alloy layer was formed as a second magnetic layer 15 over them, and a third magnetic layer 16, a non-magnetic intermediate layer 17, a fourth magnetic layer 18, a protective film 19 and a lubrication film 20 were formed in the same manner as in Example 1. FIG. 17 shows a graph for the dependence of BER on the thickness of the first magnetic layer 14. Head No. 6 in FIG. 4 was used for the evaluation of the recording performance. Brt was degraded greatly and a 00.2 peak for Co appeared in X-ray diffraction in the medium using Co-46 at. % Cr and Co-30 at. % Cr-4 at. % Ta. This is because the crystallinity of Co was disturbed by adding Cr or Ta in a great amount to the first magnetic layer, and the crystallographic orientation of the magnetic layers was deteriorated greatly. BER was degraded more in the first magnetic layer 14 containing Ta compared with the Co—Cr alloy or Co—Cr—Pt alloy. It is considered that the Ta addition caused degradation in the crystallographic orientation of the magnetic layer. With respect to the Co—Cr alloy and the Co—Cr—Pt alloy, the thickness for the best BER was larger in the material with higher Cr concentration and lower magnetization. While the material with the Cr concentration of about 19 at. % or less showed a trend that the BER degraded greatly at a thickness of 2.2 nm or more, a material with the Cr concentration of about 27 at. % or more showed no significant deterioration of BER up to about 4 nm thickness. In view of the production stability, it is preferred to use a material with higher Cr concentration which shows less fluctuation of BER relative to the thickness. FIG. 18 shows the performance for each of media at the thickness where BER was the best in each of the alloys for the first magnetic layer 14 (Test Examples 701 to 710).

### EXAMPLE 8

After forming from a first underlayer 11 to a third underlayer 13 in the same manner as in Example 1, a Co-16 at. % Cr-9 at. % Pt alloy layer with 1.5 nm thickness as a first magnetic layer 14, and a Co-22 at. % Cr-14 at. % Pt-4 at. % B-2 at. % Ta alloy layer as a second magnetic layer 15, and each of the following alloy layers was formed as a third magnetic layer 16.

Co-10 at. % Cr-13 at. % Pt-14 at. % B,

Co-12 at. % Cr-13 at. % Pt-12 at. % B,

Co-14 at. % Cr-13 at. % Pt-10 at. % B,

Co-16 at. % Cr-12 at. % Pt-8 at. % B,

Co-10 at. % Cr-14 at. % Pt-10 at. % B-2 at. % Ta,

Co-14 at. % Cr-14 at. % Pt-8 at. % B-2 at. % Ta,

Co-12 at. % Cr-12 at. % Pt-10 at. % B-2 at. % Cu,

Co-11 at. % Cr-12 at. % Pt-14 at. % B-4 at. % Cu.

A non-magnetic intermediate layer 17, a fourth magnetic layer 18, a protective film 19 and a lubrication film 20 were formed over them in the same manner as in Example 1. FIG. 19 shows the result of evaluation for this example (Test Examples 801 to 824). Head No. 6 in FIG. 4 was used for the evaluation of the recording performance. Brt of each of the magnetic layers in the figure is a design value. In Test Examples 813 to 818 in which Ta was contained in the third magnetic layer 16 and in Test Examples 810 to 812 in which the B concentration in the third magnetic layer 16 was as low as 8 at. %, Smf/N was degraded by about 1 dB at the maximum from 0.2 dB and BER was degraded by about 1 order at the maximum from 0.2 order compared with those of other test examples. It is understood that media noise increased because the melting point lowered to grow the crystal grain size when Ta was contained in the magnetic layer. Further, magnetocrystalline anisotropy decreased greatly in the case of containing Ta in the magnetic layer. Accordingly, it was necessary to increase the thickness of the third magnetic layer 16 in order to maintain the coercivity of the medium. It is understood that this also resulted in the increased noise. Further, it is understood that since the crystal grain size was grown in the magnetic layer when the B concentration was lower, noises increased also in Test Examples 810 to 812. On the other hand, BER and Smf/N in Test Examples 822 to 824 containing 4 at. % Cu in the third magnetic layer 16 tended to be improved generally more than other media. Cu addition to the magnetic layer is effective to promote the segregation of Cr and increase the magnetocrystalline anisotropy. In a case where the B concentration was as high as 14 at. % as in Test Examples 822 to 824, it was difficult to maintain the coercivity in the case of using the Co—Cr—Pt—B alloy unless the thickness was increased. However, in the case of containing Cu, since the magnetocrystalline anisotropy increases, it is understood that the coercivity can be maintained without increasing the thickness and the effect of the noise reduction due to the higher B concentration was obtained. Further, while the ratio of Brt in each of the magnetic layers to Brt of the entire medium was varied, no large difference was observed in the recording performance within the range of the ratio in this example.

### EXAMPLE 9

After forming a first underlayer 11, and a second underlayer 12 and heating the substrate, in the same manner as in Example 1, each of the following alloy layers with 8.0 nm was formed as the third underlayer 13.

Cr-10 at. % Ti,

Cr-10 at. % Ti-lat. % B,

Cr-10 at. % Ti-2 at. % B,

Cr-10 at. % Ti-3 at. % B,

Cr-10 at. % Ti-4 at. % B,

Cr-10 at. % Ti-5 at. % B,

Cr-10 at. % Ti-6 at. % B,

Cr-10 at. % Ti-7 at. % B.

A Co-16 at. % Cr-9 at. % Pt alloy layer with a 1.5 nm thickness as a first magnetic layer 14 and a Co-22 at. % Cr-14 at. % Pt-4 at. % B-2 at. % Ta alloy layer with a 7.7 nm thickness as a second magnetic layer 15 were formed over them. Then, a third magnetic layer 16 with a 6.1 nm thickness, a non-magnetic intermediate layer 17, a fourth magnetic layer 18 with a 8.1 nm thickness, a protective film 19, and a lubrication film 20 were formed over them in the same manner as in Example 1. FIG. 20 shows the result of evaluation for this example (Test Examples 901 to 908). Head No. 6 in FIG. 4 was used for the evaluation of the recording performance. Smf/N and BER were the best at the B concentration of 2 to 4 at. % in the third underlayer 13. In a case where B concentration was lower, the crystal grain size of the third underlayer 13 increased and, as a result, since the crystal grain size of the magnetic layer also was grown to increase the noises, Smf/N and BER were degraded. In a case where B concentration is higher, while the crystal grain size of the third underlayer 13 was refined, the crystallinity was degraded and, as a result, since the crystallographic orientation of the magnetic layer was degraded, Smf/N and BER were degraded. As described above, in view of the balance between the crystal grain size and the crystallinity in the third underlayer 13, about 2 to 4 at. % in the B concentration was the best.

As described above, according to the examples of the invention, it is possible to provide a longitudinal magnetic recording medium having high medium S/N ratio, with no problem for overwriting performance, excellent bit error rate and also sufficient thermal stability. Further, in combination with a high sensitive magnetic head, it is possible to provide a magnetic storage apparatus with high reliability and an areal recording density of 160 Mb/mm².

It is to be understood that the above description is intended to be illustrative and not restrictive. Many embodiments will be apparent to those of skill in the art upon reviewing the above description. The scope of the invention should, therefore, be determined not with reference to the above description, but instead should be determined with reference to the appended claims along with their full scope of equivalents.

What is claimed is:

1. A magnetic recording medium comprising a substrate, an underlayer film formed above the substrate, a magnetic film formed by stacking a first magnetic layer, a second magnetic layer, a third magnetic layer, a non-magnetic intermediate layer and a fourth magnetic layer above the underlayer film, and a protective film formed over the magnetic film, in which
each of the magnetic layers of the magnetic film is a cobalt-based alloy containing chromium,
the first magnetic layer has the least thickness among the plurality of the magnetic layers,
the second, the third and the fourth magnetic layer each further contain platinum and boron,
Brt of the second magnetic layer is smaller than Brt of the third magnetic layer,
Brt of the third magnetic layer is smaller than Brt of the fourth magnetic layer, and
the ratio of Brt of the fourth magnetic layer to Brt of the entire magnetic film is within a range from about 40% to 55%.

2. A magnetic recording medium according to claim 1, wherein
the underlayer film comprises a first underlayer, a second underlayer, and a third underlayer,
the first and the second underlayer each are an amorphous alloy layer,
the third underlayer is a chromium-titanium-boron alloy layer,
the first magnetic layer comprises a cobalt-chromium alloy,
the content of boron contained in the second magnetic layer is less than the content of boron contained in the third magnetic layer, and
the non-magnetic intermediate layer contains ruthenium.

3. A magnetic recording medium according to claim 2, wherein
the Cr concentration in the first magnetic layer is about 27 at. % or more.

4. A magnetic recording medium according to claim 2, wherein
the B concentration in the third underlayer is about 2-4 at. %.

5. A magnetic recording medium according to claim 1, wherein
the underlayer film comprises a first underlayer, a second underlayer, and a third underlayer,
the first and the second underlayer each are an amorphous alloy layer,
the third underlayer is a chromium-titanium-boron alloy layer with a boron content of about 1 at. % or more and about 6 at. % or less,
the first magnetic layer comprises a cobalt-chromium alloy with the chromium content of about 34 at. % or less,
the content of boron contained in the second magnetic layer is less than the content of boron contained in the third magnetic layer,
the content of boron contained in the third magnetic layer is about 8 at. % or more, and
the non-magnetic intermediate layer contains ruthenium.

6. A magnetic recording medium according to claim 1, wherein
the underlayer film comprises a first underlayer, a second underlayer, and a third underlayer,
the first and the second underlayer each are an amorphous alloy layer,
the third underlayer is a chromium-titanium-boron alloy layer with the boron content of about 1 at. % or more and about 6 at. % or less,
the first magnetic layer comprises a cobalt-chromium alloy with the chromium content of about 34 at. % or less,
the content of boron contained in the second magnetic layer is less than the content of boron contained in the third magnetic layer, the second magnetic layer further containing tantalum,
the content of boron contained in the third magnetic layer is about 8 at. % or more, and
the non-magnetic intermediate layer contains ruthenium.

7. A magnetic recording medium according to claim 1, wherein
the coercivity of the third and the fourth magnetic layer is about 160 kA/m or more.

8. A magnetic recording medium according to claim 1, wherein
the third and the fourth magnetic layers are magnetically separated by the non-magnetic intermediate layer.

9. A magnetic recording medium according to claim 1, wherein
all the magnetic layers in the magnetic film are magnetized in an same direction.

10. A magnetic recording medium according to claim 1, wherein
the B concentration in the fourth magnetic layer is about 10 at. % or more.

11. A magnetic recording medium comprising a substrate, an underlayer film formed above the substrate, a magnetic film formed by stacking a first magnetic layer, a second magnetic layer, a third magnetic layer, a non-magnetic intermediate layer, a fourth magnetic layer above the underlayer film, and a protective film formed over the magnetic film, in which
each of the magnetic layers of the magnetic film is a cobalt-based alloy containing chromium,
the second, the third and the fourth magnetic layer each further contain platinum and boron,
the first magnetic layer is formed directly on the underlayer film,
the second magnetic layer is formed directly on the first magnetic layer,
the third magnetic layer is formed directly on the second magnetic layer,
the fourth magnetic layer is formed over the third magnetic layer by way of the non-magnetic intermediate layer, and,
the first magnetic layer has the least thickness and the fourth magnetic layer has the greatest thickness among the plurality of magnetic layers.

12. A magnetic recording medium according to claim 11, wherein
the underlayer film comprises a first underlayer, a second underlayer, and a third underlayer,
the first and the second underlayer each are an amorphous alloy layer,
the third underlayer is a chromium-titanium-boron alloy layer,
the first magnetic layer comprises a cobalt-chromium alloy,
the content of boron contained in the second magnetic layer is less than the content of boron contained in the third magnetic layer, and
the non-magnetic intermediate layer contains ruthenium.

13. A magnetic recording medium according to claim 12, wherein
the Cr concentration in the first magnetic layer is about 27 at. % or more.

14. A magnetic recording medium according to claim 12, wherein
the B concentration in the third underlayer is about 2-4 at. %.

15. A magnetic recording medium according to claim 11, wherein
the underlayer film comprises a first underlayer, a second underlayer, and a third underlayer,
the first and the second underlayer each are an amorphous alloy layer,
the third underlayer is a chromium-titanium-boron alloy layer with the boron content of about 1 at. % or more and about 6 at. % or less,
the first magnetic layer comprises a cobalt-chromium alloy or a cobalt-chromium-platinum alloy with the chromium content of about 34 at. % or less,
the content of boron contained in the second magnetic layer is less than the content of boron contained in the third magnetic layer,
the content of boron contained in the third magnetic layer is about 8 at. % or more, and,
the non-magnetic intermediate layer contains ruthenium.

16. A magnetic recording medium according to claim 11, wherein
the underlayer film comprises a first underlayer, a second underlayer, and a third underlayer
the first and the second underlayer each are an amorphous alloy layer,
the third underlayer is a chromium-titanium-boron alloy layer with the content of boron of about 1 at. % or more and about 6 at. % or less,
the first magnetic layer comprises a cobalt-chromium alloy or a cobalt-chromium platinum alloy with the chromium content of about 34 at. % or less,
the content of boron contained in the second magnetic layer is less than the content of boron contained in the third magnetic layer, the second magnetic layer further contains tantalum,
the content of boron contained in the third magnetic layer is about 8 at. % or more, and
the non-magnetic intermediate layer contains ruthenium.

17. A magnetic recording medium according to claim 11, wherein
the coercivity of the third and the fourth magnetic layer is about 160 kA/m or more.

18. A magnetic recording medium according to claim 11, wherein
the third and the fourth magnetic layer are magnetically separated by the non-magnetic intermediate layer.

19. A magnetic recording medium according to claim 11, wherein
all the magnetic layers in the magnetic film are magnetized in an same direction.

20. A magnetic recording medium according to claim 11, wherein
the B concentration in the fourth magnetic layer is about 10 at. % or more.
